(19) United States
(12) Patent Application Publication
(10) Pub. No.: US 2015/0060365 A1
(43) Pub. Date: Mar. 5, 2015

(54) SYSTEM FOR DYNAMIC FLUIDIZED LOADING OF A LIGAND UPON CARBON MEDIA AND METHODS ASSOCIATED THEREWITH

(71) Applicant: Tusaar Inc., Lafayette, CO (US)

(72) Inventors: John WIDIRSTKY, Broomfield, CO (US); Gautam KHANNA, Louisville, CO (US); Allen QUICK, Wheatridge, CO (US)

(21) Appl. No.: 14/536,747

(22) Filed: Nov. 10, 2014

Related U.S. Application Data
(62) Division of application No. 13/725,324, filed on Dec. 21, 2012.
(60) Provisional application No. 61/580,011, filed on Dec. 23, 2011.

(51) Int. Cl. C02F 1/28; B01J 20/32

(52) U.S. Cl. CPC C02F 1/288; C02F 1/283; C02F 1/285; B01J 20/3287; C02F 2101/20
USPC 210/660; 210/263; 252/181

(57) ABSTRACT

Method and systems are provided for the removal of metal contaminants from aqueous mediums using a chamber containing activated sorptive media and a primary ligand and optionally, a secondary ligand that has been loaded onto the activated sorptive media using hydraulic loading. In at least one embodiment, the methods and systems include a pre-treatment of the sorptive media, a specific volume of the activated sorptive media within the chamber, specific pH ranges of aqueous mediums, and hydraulic loading of the primary ligand and optionally, a secondary ligand, known as dynamic fluidized loading. In at least one embodiment, pore pressures of the seeding solution within the media are at least sufficient to overcome the gravitational forces acting on the media within the column. The methods and systems provide for a highly uniform and predictable loading of the primary ligand and optionally, the secondary ligand, onto the activated sorptive media throughout the sorptive media within the chamber. Thus, the methods and system provide for effective sorption and increased capacity for metal removal from aqueous mediums.

### FIELD OF THE INVENTION

At least one embodiment of the one or more present inventions is related to the field of metal sequestration, and more particularly, to novel methods and systems for removing metals from aqueous mediums.

### BACKGROUND OF THE INVENTION

Metal contamination in the environment continues to be a challenging problem. Metal discharges can severely affect the health of our environment, particularly when contamination reaches surface waters such as ponds, lakes, streams and the like. There are many different ways of treatment for the removal of these metals from aqueous mediums.

One technique includes controlled precipitations, such as metal treatment by hydroxide precipitation. The pH of the aqueous medium is such that a metal hydroxide precipitate is formed and can be removed. This method has disadvantages in that metal precipitation is highly dependent on the metal content and pH of the aqueous medium and typically creates an effluent with only lower metal concentrations. Additionally, the metal sludge that is formed can be quite costly to remove and dispose of. Other metal removing techniques include membrane separation processes, such as microfiltration, ultrafiltration, nanofiltration, and reverse osmosis. Another technique involves the use of a chamber, such as ion-exchange columns, wherein the contaminated aqueous mediums are passed through a resin bed, such as a packed chamber or column, which immobilizes or complexes with the metals to remove them from the passing aqueous medium. Drawbacks for ion-exchange systems include that each type of ion-exchange system is typically limited to three to six different metals only and can be severely contaminated if other metals exist (i.e., a copper ion-exchange system will be adversely affected if iron is present), the pH range requires strict control so that it does not potentially destroy the resin, the presence of organics can poison the resin, and ion-exchange system are often ineffective on organometallic complexes. Therefore, there remains a need in the art for an improved and repeatable system and method of removing metals from aqueous mediums.

### SUMMARY OF THE INVENTION

It is to be understood that the one or more present inventions includes a variety of different versions or embodiments, and this Summary is not meant to be limiting or all-inclusive. This Summary provides some general descriptions of some of the embodiments, but may also include some more specific descriptions of other embodiments.

One goal of at least some embodiments of the one or more present inventions is to obtain repeatable and predictable results for removing metals from aqueous mediums. Another goal is to uniformly prepare sorptive media within a chamber for subsequent use in removal of metals within aqueous mediums.

One aspect of at least one embodiment provides a method for prepare a sorptive media within a chamber.

In at least one embodiment, a ligand-containing solution is pumped through a chamber containing less than 100% by volume of granular activated carbon to cause mechanical fluidization of at least a portion of the granular activated carbon.

Another aspect of at least one embodiment provides for activating a sorptive media by pre-treating the sorptive media with an oxidizing agent such as nitric acid; and/or further providing for a metal coordinating primary ligand, such as a benzotriazole, a benzothiazole or another compound to bind to a metal; and/or further providing for loading a primary ligand onto the activated sorptive media by a process of dynamic fluidized loading; and/or further provides for optionally loading a secondary ligand onto the activated sorptive media by a process of dynamic fluidized loading.

Yet another aspect of at least one embodiment provides for use of carboxybenzotriazole or methylbenzotriazole as a primary ligand.

Yet another aspect of at least one embodiment provides for use of dicarboxylic acids, ethylenediaminetetracetate, ascorbic acid or other metal-binding ligands as a secondary ligand (sometimes otherwise referred to as a co-ligand).

Still yet another aspect of at least one embodiment provides for an appropriate amount of time for loading of a primary ligand onto a sorptive media using dynamic fluidized loading, from about 10 minutes to at least about 240 minutes.

Yet a further aspect of at least one embodiment provides for a product for removing metal contaminants from aqueous mediums comprised of a chamber containing sorptive media that has been pre-treated with a nitric acid so as to produce an activated sorptive media. A primary ligand, and optionally a secondary ligand, are then pumped at a sufficient pressure and/or flow rate through the sorptive media to react with the specifically activated sites on the activated sorptive media, and uniformly load the primary and optionally the secondary ligand onto the activated sorptive media.

Still yet a further aspect of at least one embodiment provides a system wherein the primary ligand and optionally, the secondary ligand, of the system are pumped at a sufficient pressure and/or flow rate through the sorptive media thereby providing for dynamic fluidized loading.

Still yet a further aspect of at least one embodiment provides a system wherein the chamber containing the activated sorptive media is only partially filled with the media. In another aspect of at least one embodiment, a system is provided wherein an aqueous medium that is passed through a chamber containing an activated sorptive media, primary ligand and optionally, a secondary ligand, has a specific acidic pH range of from about 1 to 5 or even a pH range of about 0 to 9.

In another aspect of at least one embodiment, a system is provided wherein the sorptive media is composed of granular activated carbon, also commonly referred to as “GAC.” In another aspect of at least one embodiment, a system is provided wherein the sorptive media is composed of powder activated carbon, also commonly referred to as “PAC.”

In another aspect of at least one embodiment, elements to be removed from an aqueous medium include but are not limited to, aluminum, arsenic, beryllium, boron, cadmium, chromium, gadolinium, fluorine, gallium, mercury, nickel, samarium, selenium, thorium, vanadium, antimony, cobalt, holmium, lithium, molybdenum, scandium, thulium, ytterbium, barium, copper, iron, neodymium, silver, tin, yttrium, cadmium, dysprosium, lanthanum, nickel, strontium, titanium, zinc, cesium, erbium, lead, mercury, palladium, tungsten, thallium, cerium europium, lutetium, pradeodymium, terbium, uranium, manganese, compounds thereof and mixtures thereof.

In addition to the foregoing, a method of preparing a material for use in treating a fluid containing metals is provided, the method comprising: a) causing a chamber to be partially filled with a granular activated carbon; and b) causing a ligand seeding solution to flow through the chamber, wherein pore pressures of the ligand seeding solution within the granular activated carbon are at least high enough to overcome gravitational forces acting on the granular activated carbon within the column, thereby causing movement of at least a portion of the granular activated carbon as the ligand seeding solution is transmitted through the chamber.

A system for use in treating a fluid containing metals is also provided, the system comprising a chamber partially filled with granular activated carbon, wherein the granular activated carbon includes at least one of a primary ligand associated with the granular activated process of dynamic fluidized loading. In at least one embodiment, a secondary ligand is also associated with the primary ligand. In at least one embodiment, the chamber is filled with between about 10% to 85% by volume of the granular activated carbon. In at least one embodiment, at least a portion of the chamber is transparent.

Another aspect of the present invention is a mass of activated carbon impregnated with a metal binding ligand. The mass of activated carbon is characterized in that (i) the amount of the impregnated metal binding ligand does not exceed 12% wt % of the mass of activated carbon and (ii) no more than 5% of the impregnated metal binding ligand will leach into an aqueous solution of deionized water, nitric acid and cupric nitrate, containing 100 ppm copper at pH 3.5 and a temperature of 25° C. passed through a bed of said activated carbon in a column having a diameter to length ratio of 1:10, respectively, at a rate of 0.14 bed volumes/minute for 500 bed volumes.

Another aspect of the present invention is a method of preparing sorptive media, wherein the method comprises: treating a mass of sorptive media with a solution containing a primary metal-binding ligand in a chamber under conditions in which the mass of sorptive media is permitted to move freely as it is treated with the ligand-bearing solution to load the primary metal-binding ligand onto the mass of sorptive media.

Various embodiments of the one or more present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are understood by those of ordinary skill in the art to encompass obvious improvements and modifications thereto.

Additional advantages of the one or more present inventions will become readily apparent from the following discussion, particularly when taken together with the accompanying drawings.

### BRIEF DESCRIPTION OF THE DRAWINGS

To further clarify the above and other advantages and features of the one or more present inventions, a more particular description of the one or more present inventions is rendered by reference to specific embodiments thereof which are illustrated in the appended drawings. It should be appreciated that these drawings depict only typical embodiments of the one or more present inventions and are therefore not to be considered limiting of its scope. The one or more present inventions are described and explained with additional specificity and detail through the use of the accompanying drawings listed below.

FIG. 1 shows a schematic of a chamber containing granular activated carbon media in accordance with at least one embodiment of the one or more present inventions.

FIG. 2 shows a schematic of the chamber of FIG. 1 during dynamic fluidized loading of the primary ligand and secondary ligand through the chamber containing the granular activated carbon media, wherein the granular activated carbon media is shown moving in response to the primary ligand being transmitted through the chamber.

FIG. 3 is a graph showing the individual carbon capacity for loading of a primary ligand, specifically carboxybenotriazole. SGL, MRX, CAL, BPL, CPG denote types of granular activated carbon provided by the CALGON Carbon Corporation. PC denotes a type of granular activated carbon provided by SAI Corp.

FIG. 4 is a graph that compares the amount of carboxybenzotriazole that was loaded onto granular activated carbon media over a period of time using dynamic fluidized loading when the granular activated carbon media was fluidized to approximately 15% above the resting bed height, using 112 grams of granular activated carbon (as indicated by the triangles) and 95% above the resting bed height using 362 grams of granular activated carbon (as indicated by the diamonds).

FIG. 5 shows the results of copper sequestration within a chamber containing activated carbon media that was loaded with carboxybenzotriazole using the plug flow method. Results were conducted in duplicate.

FIG. 6 shows the results of copper sequestration within a chamber containing activated carbon media that was loaded with carboxybenzotriazole using the dynamic fluidized method. Results were conducted in duplicate.

FIG. 7 compares the loading rate of a chamber containing activated carbon media with carboxybenzotriazole using dynamic fluidized loading, when the activated carbon media was fluidized to approximately 15% above the resting bed height (as indicated by the triangles) and 95% above the resting bed height (as indicated by the diamonds).

FIG. 8 is a graph depicting the results of an experiment as described in Example 1.

FIG. 9 is a graph depicting the results of an experiment as described in Example 3.

FIG. 10 is a graph depicting the results of an experiment as described in Example 4.

FIG. 11 is a graph depicting the results of an experiment as described in Example 5.

The drawings are not necessarily to scale.

### ABBREVIATIONS AND DEFINITIONS

The following definitions and methods are provided to better define the present invention and to guide those of ordinary skill in the art in the practice of the present invention. Unless otherwise noted, terms are to be understood according to conventional usage by those of ordinary skill in the relevant art.

The term “aqueous medium” refers to any liquid made with water or to water. An aqueous medium may also contain one more target species, such as one more metals, from any type of source.

The term “dynamic fluidized loading” refers to the sorptive media contained in a chamber under sufficient flow rate and/or fluid pressures from a seeding solution so that at least a portion of the sorptive media and seeding solution both behave as a fluid within the chamber (that is, at least a portion of the media and seeding solution are flowing).

The term “ligand” refers to an ion or a molecule that has an affinity for binding to a metal ion/atom or a second molecule containing a metal ion/atom to form metal complexes. The nature of metal-ligand bonding can range from covalent to ionic. Generally, ligands are viewed as electron donors and metals as electron acceptors.

Various components are referred to herein as “operably associated.” As used herein, “operably associated” refers to components that are linked together in operable fashion, and encompasses embodiments in which components are linked directly, as well as embodiments in which additional components are placed between the two linked components.

The terms “sorb” and/or “sorptive” and/or “sorbent” refer to the principle of one type of material or substance being retained (whether onto or into) by another material or substance through chemical interaction, attachment, linkage or bonding. The process can include adhesion or attraction of one material or substance to the surface of another material or substance or the penetration of a substance or material into the inner structure of another substance or material. For example, an embodiment of the one or more present inventions contemplates that activated sorptive media loaded with at one or more primary ligands and optionally, a secondary ligand, and will sorb one or more metal ions in an aqueous medium. Other terms that can be described to include this interaction include sorption, trapping, and binding, all of which are contemplated to be within the scope of sorb and/or sorptive and/or sorbent.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements

### DETAILED DESCRIPTION

One or more embodiments of the one or more present inventions are directed to a method and/or a system for pretreating a sorptive media, such as granular activated carbon, with a primary ligand and optionally, a secondary ligand suitable for subsequent sequestration of metals residing within a solution, such as an aqueous solution containing one or more metals. In at least one embodiment, a column or a chamber is partially filled with activated carbon, such as granular activated carbon. Thereafter, and as part of pretreatment of the activated carbon, a solution containing a primary ligand and optionally, a secondary ligand, is passed through the column or chamber to expose the activated carbon contained therein to the solution containing the primary ligand and optionally, a secondary ligand, wherein the exposure comprises at least partially fluidizing the media bed of activated carbon.

In general, the sorptive media is pretreated with a ligand-bearing solution under conditions that permit intimate contact and mixing of the sorptive media and the ligand-bearing solution. For example, the contact may occur in a batch reactor, a continuous reactor, or a semi-batch reactor. In each such embodiment, however, the sorptive media is preferably permitted to move freely relative to itself, the ligand-bearing solution and to the vessel in which the sorptive media is being treated with the ligand-bearing solution. Stated differently, it is generally preferred that the sorptive media not be presented to the ligand-bearing solution as a stationary bed (i.e., it is presented as a non-stationary bed). Thus, for example, the treatment may occur in a stirred tank reactor in which the sorptive media is dispersed and moves freely in the ligand-bearing solution, with the operation being carried out in batch, semi-batch or continuous mode.

In some embodiments, a stirred tank reactor may affect the size or other physical characteristics of the sorptive media. As a result, in some embodiments it is generally preferred that a free-flowing dispersion of the sorptive media in the ligand-bearing solution be achieved without the use of an impeller.

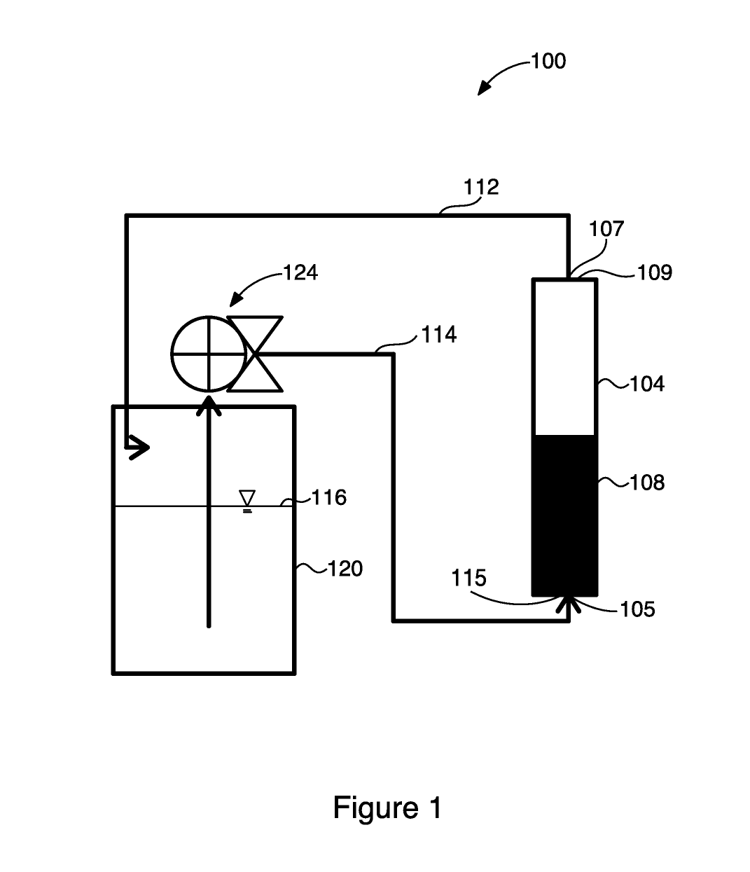

Referring now to FIG. 1, a schematic is shown of at least a portion of a media pretreatment system 100 in accordance with one embodiment of the present invention. The media pretreatment system 100 includes a chamber, such as a column 104, for holding a sorptive material or media, such as granular activated carbon 108. The column 104 has an inlet 105, an inlet filter 115, an outlet 107, and an outlet filter 109 and it is fluidly interconnected via conduit 112 and conduit 114 to a container 120 holding a ligand-bearing seeding solution 116. In at least one embodiment, the media pretreatment system 100 includes one or more valves and/or pumps 124 for conveying the ligand-bearing seeding solution 116.

Referring still to FIG. 1, the column 104 is partially filled with the activated sorptive media. More particularly, a media material such as granular activated carbon 108 is placed within the column 104; however, sufficient volume above the granular activated carbon 108 is left empty to allow for at least partially mechanically fluidizing the granular activated carbon, as further described below, when the seeding solution is conveyed through the column 108. Accordingly, the granular activated carbon 108 is placed to only partially fill the column 104 from about 10% to about 85% by volume, and more preferably, from between about 25% to about 75%, and more preferably yet, from between about 40% to about 60%.

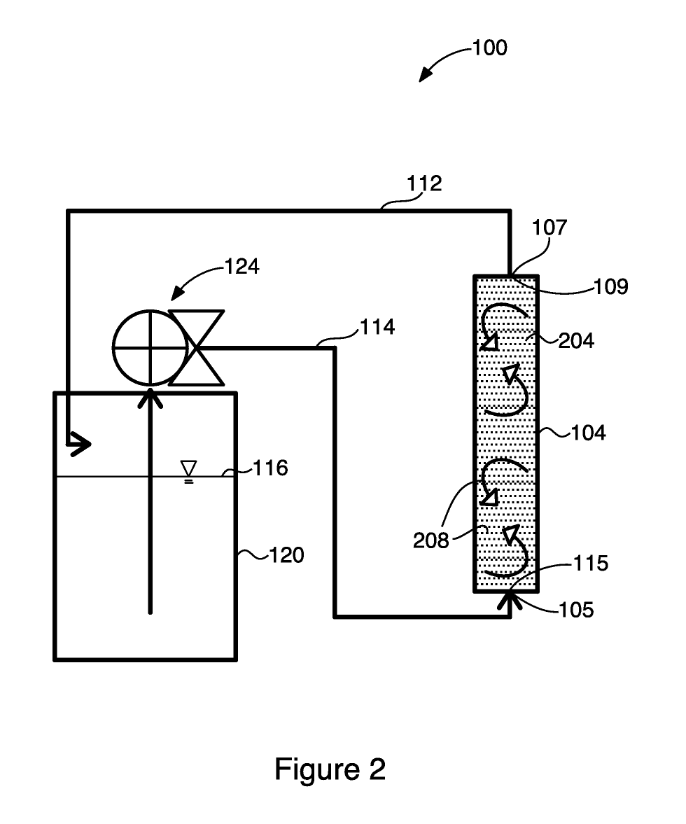

Referring now to FIG. 2, a schematic is provided of the system 100 wherein the ligand-containing solution 116 is conveyed, such as by pumping, through the chamber 104 containing the granular activated carbon 108 using dynamic fluidized loading. The at least partially fluidized activated carbon 204 moves within the column 104. Accordingly, the arrows 208 within the column 104 indicate movement within the chamber due to the pressurized flow of the ligand-containing solution 116 through the granular activated carbon 108. Advantageously, the dynamic fluidized loading of the granular activated carbon 108 with the ligand-containing solution 116 allows the granular activated carbon 108 to be loaded with a commercially viable and substantially uniform amount of ligand throughout granular activated carbon 108 residing with the column 104.

In accordance with at least one embodiment, during dynamic fluidized loading of the media, pore pressures within the media are at least high enough to overcome the gravitational forces acting on the media 108 within at least a portion of the column 104, thereby causing movement 208 of the media particles in the column 104 as the seeding solution 116, i.e., the ligand-containing solution, is transmitted through the column 104.

In accordance with the present invention, a sorptive media is impregnated with at least a primary compound (ligand) having a capacity for binding metal. According to one embodiment of the present invention the primary compound contains a metal binding portion to coordinate with a metal and a hydrophobic portion. The metal binding portion may be polar and relatively hydrophilic, the portion of the compound that is attracted to surfaces and solvents less polar than water is termed hydrophobic.

In certain embodiments, the primary ligand is an amphipathic compound containing both hydrophilic and hydrophobic portions. For example, is an amphipathic polyaminocarboxylic acid chelator such as triethylenetetraminehexaacetic acid or diethylenetriamine-pentaacetic acid. In another embodiment, the amphipathic compound is an amphipathic polycyclic heterocycle. In one embodiment, the amphipathic compound is aromatic or heteroaromatic. Exemplary polycyclic heterocycles include the porphyrins, porphyrazins, corrins, porphyrinogens, benzotriazoles and benzothiazoles. In one embodiment, for example, the amphipathic metal binding ligand is a benzotriazole corresponding to Formula 1

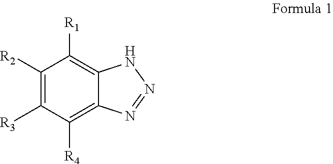

wherein R₁, R₂, R₃, and R₄ are independently hydrogen, hydrocarbyl, substituted hydrocarbyl, (—NO₂) or cyano (—CN). In one such embodiment, one of R₁, R₂, R₃, and R₄ is alkyl, e.g., methyl, and the other three of R₁, R₂, R₃, and R₄ are hydrogen. In another embodiment, one of R₁, R₂, R₃, and R₄ is carboxy (—COOH) and the other three of R₁, R₂, R₃, and R₄ are hydrogen. Thus, for example, in one embodiment the amphipathic metal binding ligand is a benzotriazole corresponding to Formula 2 (4-methyl-1H-benzotriazole), Formula 3 (5-methyl-1H-benzotriazole), Formula 4 (benzotriazole) or Formula 5 (carboxybenzotriazole):

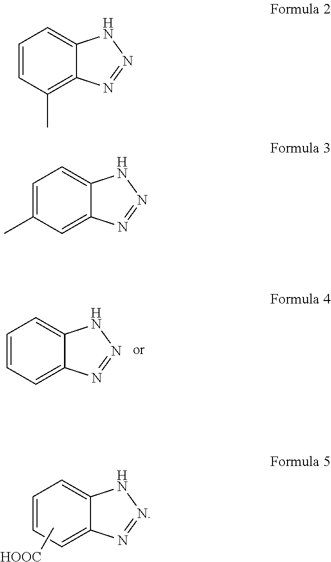

In one embodiment, the primary ligand is a benzothiazole corresponding to Formula 6:

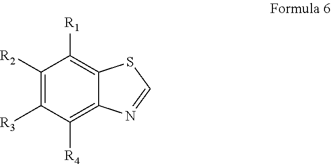

wherein R₁, R₂, R₃, and R₄ are independently hydrogen, hydrocarbyl, substituted hydrocarbyl, (—NO₂) or cyano (—CN). In one such embodiment, one of R₁, R₂, R₃, and R₄ is alkyl, e.g., methyl, and the other three of R₁, R₂, R₃, and R₄ are hydrogen. In another embodiment, one of R₁, R₂, R₃, and R₄ is carboxy (—COOH) and the other three of R₁, R₂, R₃, and R₄ are hydrogen. Thus, for example, in one embodiment the amphipathic metal binding ligand is a benzothiazole corresponding to Formula 7 (4-methyl-1H-benzothiazole), Formula 8 (5-methyl-1H-benzothiazole), Formula 9 (benzothiazole) or Formula 10 (carboxybenzothiazole):

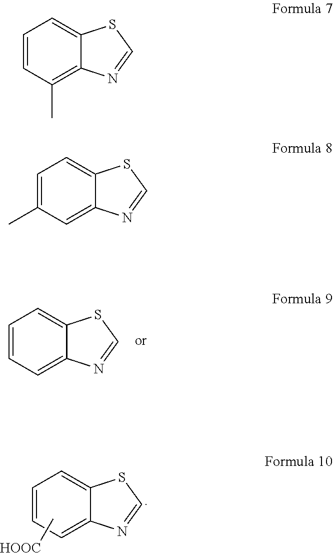

Without wishing to be bound by any particular theory, it has been suggested that the thiazole ring of benzothiazoles and the triazole ring of benzotriazoles are responsible for the metal binding properties of these compounds. The thiaxone and triazole rings form strong coordinate bonds with many environmentally relevant transition metals. Metals that may be bound by the ring include positively charged ions of copper, zinc, nickel, mercury, cadmium, lead, gold, silver, iron, and others and also include complexes containing these metals regardless of their charge. The ring may also bind arsenic, selenium, and other metalloids. Many of these metals and metalloids are present in relatively high concentration in Rocky Mountain region acid mine drainage and many industrial wastewaters, and are significant with regards to biological toxicity responses of invertebrates and vertebrates. The metal binding ability is also robust for a pH range relevant to many environmental situations and industrial scenarios where heavy metal contamination is a serious problem or where metals recovery is desired: acid mine drainages, industrial wastewater discharges (e.g., leather tanning, metal plating, microchip etc), precious metals mining operations (e.g., heap leach, cyanide leach) and radionuclide processing.

In columns or chambers, typically two different ligands are used: a primary ligand and optionally, a complementary secondary ligand. Examples of primary ligands are benzotriazoles and benzothiazoles. Benzotriazoles are heterocyclic compounds that are commonly used as corrosion inhibitors and have a molecular formula of C₆H₄N₃H. Examples of a benzotriazole are carboxybenzotriazole (CBT) and methylbenzotriazole (or MeBT). Benzothiazoles are also heterocyclic compounds that are commonly used as starting materials for many commercial products, but have a molecular formula of C₇H₅NS. Thus one embodiment of the one or more present inventions contemplates using a benzotriazole, more specifically CBT or MeBT, or a benzotriazole as a primary ligand.

Another embodiment of the one or more present inventions contemplates using one or more secondary ligands. In one embodiment, the primary ligand and the secondary ligand each have an affinity for the sorptive media, such that the primary ligand and the secondary ligand bind with or otherwise adhere to the sorptive media. As previously noted, the primary ligand may be any suitable metal binding ligand, preferably an amphipathic, heterocyclic metal-coordinating compound. In one such example, the primary ligand may be selected based at least in part on a charge distribution which maintains at least approximately, a charge neutrality at pH of less than about 7. The secondary ligand may similarly be any suitable metal-coordinating compound having a lower molecular weight than the primary ligand. In one exemplary embodiment, the secondary ligand can be selected from the group comprising dicarboxylic acids, ethylenediaminetetraacetate (EDTA) and ascorbic acid.

Dicarboxylic acids are compounds that contain two carboxylic acid functional groups and having the molecular formula of C₂O₄H₂R, where R may be an alkyl, alkenyl, alkynyl or aryl group. Examples of dicarboxylic acids include oxalic acid, malonic acid, malic acid, succinic acid, glutaric acid, adipic acid, pimelic acid, suberic acid, azelaic acid, and sebacic acid. Thus, another embodiment of the one or more present inventions contemplates using one or more of these dicarboxylic acids as a secondary ligand.

Ethylenediaminetetraacetate, more commonly known as EDTA, is a hexadentate ligand, polyamino carboxylic acid and chelating agent, having a molecular formula of C₁₀H₁₆N₂O₈. Thus, another embodiment of this present invention contemplates using EDTA as a secondary ligand.

Ascorbic acid is a chelating agent having a molecular formula of C₆H₈O₆. Thus, another embodiment of the one or more present inventions contemplates using ascorbic acid as a secondary ligand.

Activated carbon is a form of carbon that has been processed to make it extremely porous, and thus, to have a very large surface area available for sorption or chemical reactions. Sufficient activation may come from the high surface area (or with further chemical treatment, such as loading of a ligand onto the activated carbon) to enhance the sorption properties of the material. Activated carbon can take the form of granulated, powder or a pelletized form.

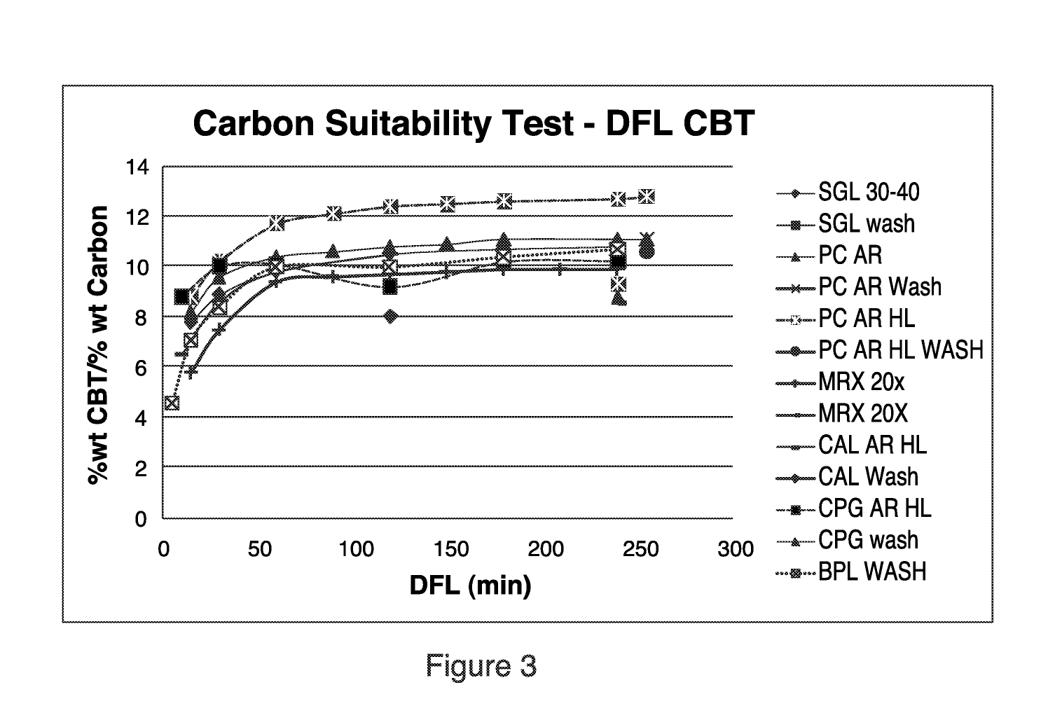

Carbon is well-suited as a sorptive media and is readily available. However, the properties of carbon differ according to manufacturers and the regions where the carbon is initially obtained. At least one embodiment provides for use of granular activated carbon as the media. Activated carbons are commercially available from a number of sources both domestically and internationally. FIG. 3 shows a graph of the ligand loading capacity of various granular carbons that have been pre-treated, and thus activated, with nitric acid or another suitable oxidizing agent. For FIG. 3, the objective was to determine loading characteristics of the primary ligand and the ability of each activated carbon type to sequester metals at low levels and retain metals. The results show that PC AR HL had the highest ligand loading potential.

In one embodiment, the carbon is a coal-based bituminous/sub-bitumous granulated active carbon (GAC) or a powdered activated carbon (PAC). Typically, the activated carbon will have a size of less than 1 mm. In general, PAC is made up of crushed or ground carbon particles, 95-100% of which will pass through a designated mesh sieve. According to some, granular activated carbon has been defined as the activated carbon retained on a 50-mesh sieve (0.297 mm) and PAC material as finer material, while ASTM classifies particle sizes corresponding to an 80-mesh sieve (0.177 mm) and smaller as PAC. Regardless of whether the activated carbon is classified as PAC or GAC, in one embodiment the activated carbon has a hardness of at least 90. By way of further example, in one such embodiment the sorptive media is a GAC or PAC carbon having an ash content of at least 10%. By way of further example, in one such embodiment the sorptive media is a GAC or PAC carbon having an abrasion resistance number of at least 75.

At least one embodiment of the one or more present inventions provides for a preferable amount of sorptive media to be added to a chamber. More specifically, in at least one embodiment, the sorptive media is granular activated carbon and the suitable amount to be added to a chamber is less than 100% by volume of the chamber, but more preferably, between 10% to 85% by volume of the chamber. In at least one embodiment, at least a portion of the chamber is transparent for visually assisting with loading the activated carbon with a ligand seeding solution, such that movement of the activated carbon within the chamber can be visually monitored.

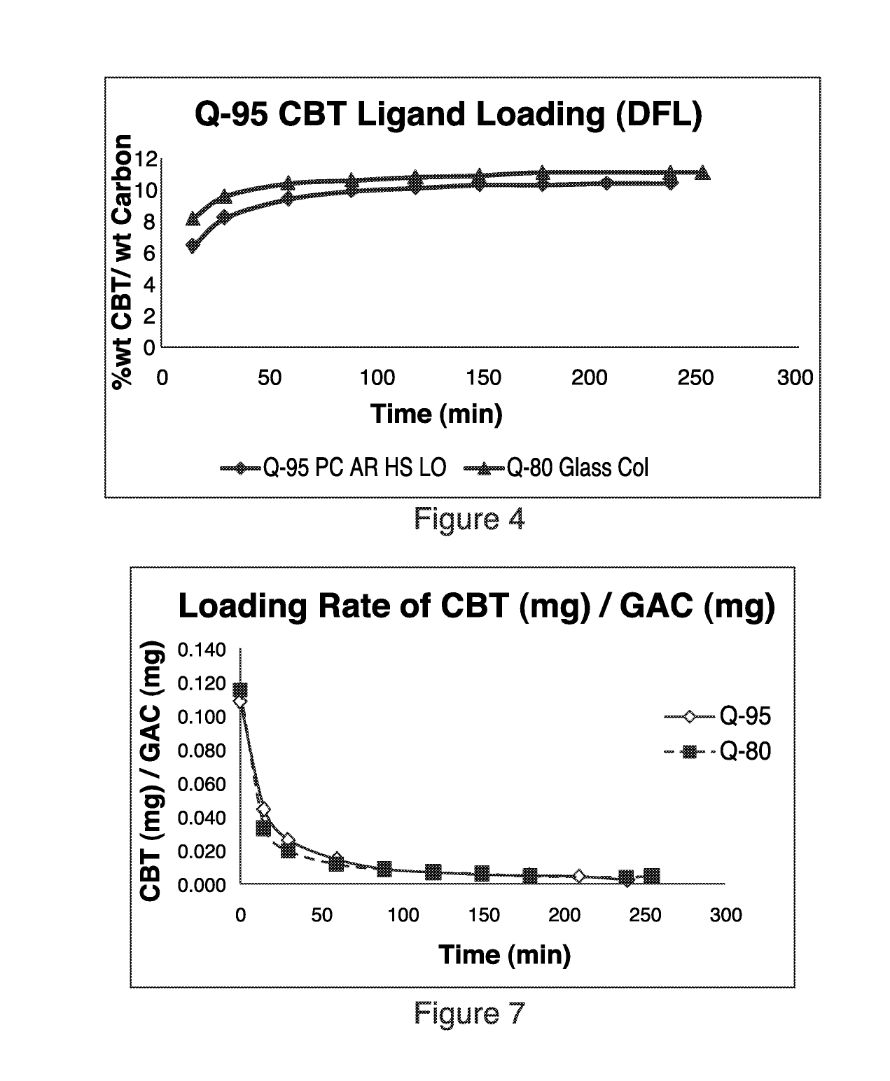

Referring now to FIG. 4, a graph is shown that compares the amount of carboxybenzotriazole that was loaded onto activated carbon media over a period of time using dynamic fluidized loading when the activated carbon media was fluidized to approximately 15% above the resting bed height using 112 grams of granular activated carbon (as indicated by the triangles). As shown, dynamic fluidized loading results in increased uniform contact between the ligand and the activated sites on the granulated carbon. FIG. 4 also includes a second set of data points wherein the activated carbon media was fluidized to approximately 95% above resting bed height using 362 grams of granular activated carbon (as indicated by the diamonds). Note that the maximum amount of loading of the ligand, carboxybenzotriazole, is not proportional to the amount of granular activated carbon in the chamber.

A conventional technique for loading of the ligand onto a sorptive media in a chamber calls for a plug flow technique. In the plug flow technique, the column is tightly packed with sorptive media, thereby preventing movement of the media relative to itself and the column and the flow of the solution containing the ligand is typically in one direction through the sorptive media (i.e., from the bottom of the chamber to the top of the chamber). This technique results in uneven and non-uniform distribution of the ligand throughout the sorptive media because the ligand is repetitively forming complexes with itself, rather than complexing with the granular activated carbon because of the uneven distribution of the ligand throughout the chamber. This problem is overcome by using pressure and/or flow rate, that is, dynamic fluidized loading, of the ligand onto the granular carbon activated media.

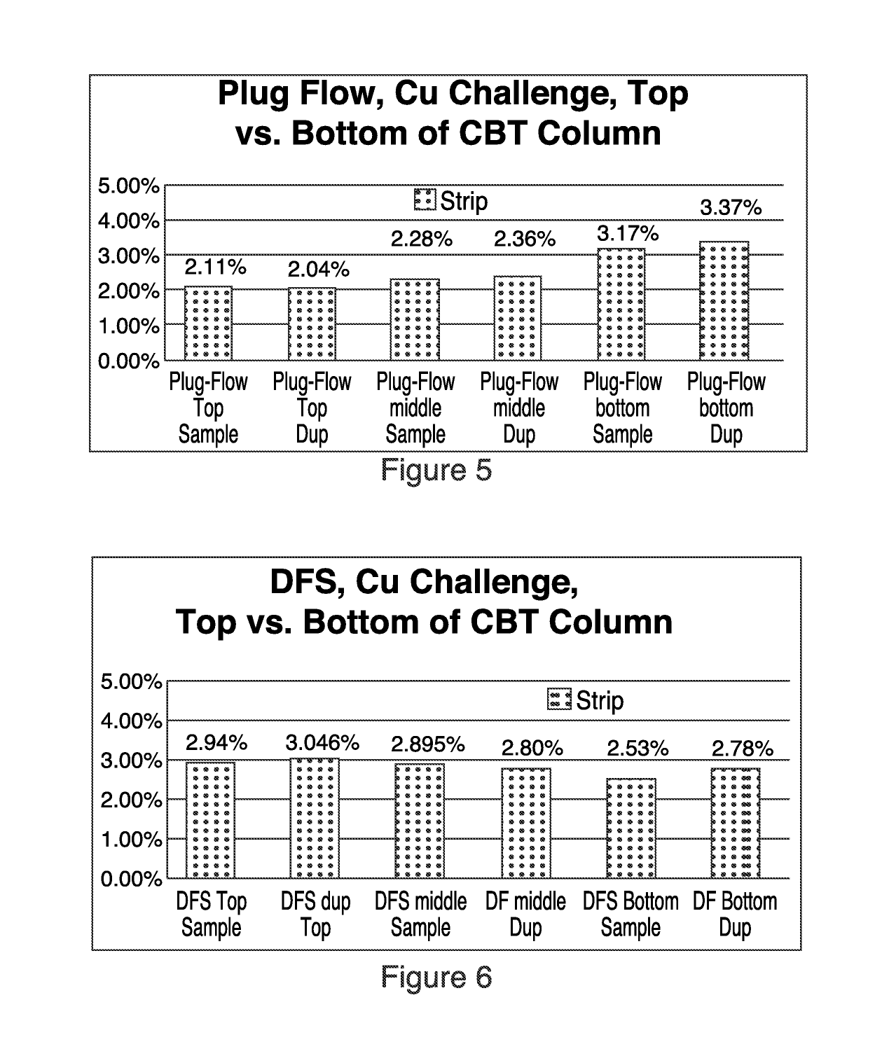

To further corroborate the advantage of dynamic fluidized loading over plug flow, experiments were conducted using samples of sorptive media (granular activated carbon) after loading with carboxybenzotriazole in a column using plug flow and dynamic loading techniques. Carbon samples were taken from various positions of each of the loading column and they were tested for copper capacity individually. FIG. 5 shows the results of copper sequestration using activated carbon media that was loaded with carboxybenzotriazole by the plug flow method, and FIG. 6 shows the results of copper sequestration using activated carbon media that was loaded with carboxybenzotriazole by the dynamic fluidized loading method. Experiments were conducted in duplicate. As shown, the variation of copper sequestration within the chamber that was loaded using the plug method was greater than the variation of copper sequestration within the chamber that was loaded using the dynamic fluidized loading method.

Further experimentation was also done to determine if an increased amount of contact time between a ligand and the granular activated carbon media using dynamic fluidized loading resulted in more ligand being bound to the activated carbon. FIG. 7 shows the results of this trial in that the greatest amount of ligand loaded onto the granular carbon activated media begins to plateau after about 50 minutes.

In one embodiment, the sorptive media is impregnated with the primary and secondary ligands in any suitable manner and in any desired order. For example, the primary ligand may be loaded onto the sorptive media prior to adding the secondary ligand. In another example, the secondary ligand is loaded onto the sorptive media prior to the primary ligand. In yet another example, the primary ligand and the secondary ligand are loaded onto the sorptive media at substantially the same time. In addition, the sorptive media may be dried prior to, and/or after, adding the primary ligand and/or the secondary ligand.

One embodiment of the one or more present inventions provides for a method of pre-treating sorptive media within a column or chamber by activating the sorptive media with an acid, specifically nitric acid. The sorptive media can be pre-treated for example, by mixing the sorptive media with an acid and water in an Erlenmeyer flask. Generally, the steps include: 1) adding water, deionized or not, to the Erlenmeyer flask; adding the acid to the Erlenmeyer flask; 3) adding the granular carbon slowly to the water/acid mixture to the Erlenmeyer flask and mixing; and 4) heating the granular carbon/acid/water mixture so that the temperature of the mixture is approximately 80° C. for approximately 3 hours. One embodiment of the one or more present inventions provides for carbon or granular carbon as the sorptive media and specifically nitric acid as the acid to activate the carbon.

In other embodiments, the sorptive media is pretreated with an oxidizing agent other than nitric acid before the sorptive media is impregnated with the primary or the primary and secondary ligands. For example, in one such embodiment the sorptive media may be treated with a peroxide (e.g., hydrogen peroxide, sulfuric acid, persulfates (e.g., ammonium persulfate), peroxydisulfuric acid, permanganates (e.g., potassium permanganate), perborates (e.g., sodium perborate), and ozone. Oxidizing agent concentration will vary depending upon the oxidizing potential of the individual agent with concentrations, for example, being in the range of about 15-70% by volume for nitric acid, and about 2% to 30% by volume for hydrogen peroxide.

A mass of activated carbon impregnated with a metal binding ligand (i.e., a primary ligand) in accordance with the process of the present invention will generally comprise up to about 12 wt % of the primary ligand. For example, in one embodiment, the impregnated active carbon contains less than about 11 wt % of the primary ligand. By way of further example, in one such embodiment the impregnated activated carbon contains less than about 10 wt % of the primary ligand. By way of further example, in one such embodiment the impregnated activated carbon contains less than about 9 wt % of the primary ligand. By way of further example, in one such embodiment the impregnated activated carbon contains less than about 8 wt % of the primary ligand. By way of further example, in one such embodiment the impregnated activated carbon contains less than about 7 wt % of the primary ligand. By way of further example, in one such embodiment the impregnated activated carbon contains less than about 6 wt % of the primary ligand. By way of further example, in one such embodiment the impregnated activated carbon contains less than about 6 wt % of the primary ligand. In each of the foregoing examples and embodiments recited in this paragraph the primary ligand may be a benzotriazole corresponding to Formula 1, Formula 2, Formula 3, Formula 4 (benzotriazole) or Formula 5 or a benzothiazole corresponding to Formula 6, Formula 7 (4-methyl-1H-benzothiazole), Formula 8 (5-methyl-1H-benzothiazole), Formula 9 (benzothiazole) or Formula 10 (carboxybenzothiazole).

A mass of activated carbon impregnated with a metal binding ligand (i.e., a primary ligand) in accordance with the process of the present invention will generally comprise at least about 1 wt % of the primary ligand. For example, in one embodiment, the impregnated active carbon contains at least about 2 wt. % of the primary ligand. By way of further example, in one such embodiment the impregnated activated carbon contains at least about 3 wt % of the primary ligand. By way of further example, in one such embodiment the impregnated activated carbon contains at least about 4 wt % of the primary ligand. In each of the foregoing examples and embodiments recited in this paragraph the primary ligand may be a benzotriazole corresponding to Formula 1, Formula 2, Formula 3, Formula 4 (benzotriazole) or Formula 5 or a benzothiazole corresponding to Formula 6, Formula 7 (4-methyl-1H-benzothiazole), Formula 8 (5-methyl-1H-benzothiazole), Formula 9 (benzothiazole) or Formula 10 (carboxybenzothiazole).

A mass of activated carbon impregnated with a metal binding ligand (i.e., a primary ligand) in accordance with the process of the present invention will generally comprise between about about 1 wt % and about 12 wt. % of the primary ligand. For example, in one embodiment, the impregnated active carbon contains between about 1 wt. % to and about 11 wt. % of the primary ligand. By way of further example, in one such embodiment the impregnated activated carbon contains between about 2 wt. % to and about 11 wt. % of the primary ligand. By way of further example, in one such embodiment the impregnated activated carbon contains between about 2 wt. % to and about 10 wt. % of the primary ligand. By way of further example, in one such embodiment the impregnated activated carbon contains between about 3 wt. % to and about 11 wt. % of the primary ligand. By way of further example, in one such embodiment the impregnated activated carbon contains between about 3 wt. % to and about 10 wt. % of the primary ligand. By way of further example, in one such embodiment the impregnated activated carbon contains between about 3 wt. % to and about 9 wt. % of the primary ligand. By way of further example, in one such embodiment the impregnated activated carbon contains between about 3 wt. % to and about 8 wt. % of the primary ligand. By way of further example, in one such embodiment the impregnated activated carbon contains between about 4 wt. % to and about 11 wt. % of the primary ligand. By way of further example, in one such embodiment the impregnated activated carbon contains between about 4 wt. % to and about 10 wt. % of the primary ligand. By way of further example, in one such embodiment the impregnated activated carbon contains between about 4 wt. % to and about 9 wt. % of the primary ligand. By way of further example, in one such embodiment the impregnated activated carbon contains between about 4 wt. % to and about 8 wt. % of the primary ligand. By way of further example, in one such embodiment the impregnated activated carbon contains between about 4 wt. % to and about 7 wt. % of the primary ligand. In each of the foregoing examples and embodiments recited in this paragraph the primary ligand may be benzotriazole corresponding to Formula 1, Formula 2, Formula 3, Formula 4 (benzotriazole) or Formula 5 or a benzothiazole corresponding to Formula 6, Formula 7 (4-methyl-1H-benzothiazole), Formula 8 (5-methyl-1H-benzothiazole), Formula 9 (benzothiazole) or Formula 10 (carboxybenzothiazole).

In general, activated carbons impregnated with a (primary) metal binding ligand as described herein demonstrate low leach rates. More specifically, leach rates may be determined, for example, by passing an aqueous solution at pH 3.5 through a bed of the activated carbon. In one specific exemplary embodiment, the amount of leaching of the (primary) metal binding ligand may be determined, for example, by passing 500 bed volumes of an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute. For example, in one embodiment no more than 5% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 4.5% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 4% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 3.5% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 3% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 2.5% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 2% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 1.5% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 1% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. By way of further example, in one embodiment no more than 0.5% of the (primary) metal binding ligand will leach from the impregnated activated carbon and into an aqueous solution of deionized water, nitric acid and cupric nitrate (100 ppm copper) at pH 3.5 and a temperature of 25° C. through a bed of the activated carbon having a diameter to length ratio of 1:10 at a rate of 0.14 volumes per minute for 500 bed volumes. In each of the foregoing examples and embodiments recited in this paragraph the primary ligand may be a benzotriazole corresponding to Formula 1, Formula 2, Formula 3, Formula 4 (benzotriazole) or Formula 5 or a benzothiazole corresponding to Formula 6, Formula 7 (4-methyl-1H-benzothiazole), Formula 8 (5-methyl-1H-benzothiazole), Formula 9 (benzothiazole) or Formula 10 (carboxybenzothiazole).

In general, and independent of the extent of loading of the primary ligand onto the activated carbon, the amount of (primary) metal binding ligand impregnated into the activated carbon may be assessed by treating the activated carbon with an aqueous solution at pH 12. More specifically, an aqueous solution at pH 12 will quantitatively remove the (primary) metal binding ligand from the impregnated activated carbon. For example, the amount of (primary) metal binding ligand may be determined by passing an aqueous solution at pH 12 through a bed of the activated carbon. In one specific exemplary embodiment, the amount of (primary) metal binding ligand may be determined by passing 5 liters of an aqueous solution (5 gm/liter NaOH in deionized water) at a pumping rate of 5 ml per minute through a bed of the activated carbon (4 gm activated carbon sample) having a diameter to length ratio of 1:10.

During a treatment process, the sorptive media is combined with an aqueous solution containing at least metal to be separated from therefrom. In one embodiment, the sorptive media is impregnated with the primary but not a secondary ligand. In another embodiment, the sorptive media is impregnated with a primary and a secondary ligand. In yet another embodiment, the sorptive media is impregnated with a primary ligand and a secondary ligand (in soluble form) is introduced to the aqueous solution before, after, or simultaneously with the sorptive media (impregnated with the primary ligand). In these various embodiments, the primary ligand or the primary and secondary ligands coordinate or otherwise sequester the metal in the aqueous solution and bind the metal to the sorptive media thus removing the metal from the aqueous solution. In one embodiment, the aqueous solution containing the metal to be sequestered and treated with the sorptive media may have a pH in the range of 0 to 9.

The one or more present inventions may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The one or more present inventions, in various embodiments, include components, methods, processes, systems and/or apparatus substantially as depicted and described herein, including various embodiments, subcombinations, and subsets thereof. Those of skill in the art will understand how to make and use the one or more present inventions after understanding the present disclosure.

Moreover, though the description of the invention has included description of one or more embodiments and certain variations and modifications, other variations and modifications are within the scope of the invention (e.g., as may be within the skill and knowledge of those in the art, after understanding the present disclosure). It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The one or more present inventions, in various embodiments, includes providing devices and processes in the absence of items not depicted and/or described herein or in various embodiments hereof, including in the absence of such items as may have been used in previous devices or processes (e.g., for improving performance, achieving ease and/or reducing cost of implementation).

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

### EXAMPLES

The following non-limiting examples are provided to further illustrate the present invention. It should be appreciated by those of skill in the art that the techniques disclosed in the examples that follow represent approaches the inventors have found function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

Activated carbon preparation general procedure: Powdered or Granular activated carbon was washed and abraded to remove fines, edges, and particles from within the activated carbon pore structure. An oxidant or combination of oxidants (nitric acid, hydrogen peroxide, ammonium persulfate, etc.) was combined with the washed and abraded carbon for a period of 15 minutes to 3 days, and optionally heated to increase the rate of reaction. The treated carbon was then washed to remove excess oxidant and fines. A solution containing the ligand (e.g., carboxybenzotriazole) was combined with the treated carbon in such a way that the carbon is fluidized. This could be done, for example, by placing the carbon in a column and flowing the ligand solution through the column at such a rate that the carbon bed expands 5%-150%. The solution containing the ligand was passed through the treated carbon in a single pass or cycled through in multiple passes for time periods up to 24 hrs. The treated carbon was then washed to remove excess ligand.

### Example 1

Carbon+CBT (C+CBT) Media was prepared as generally described above except that the activated carbon was ground to 40/60 mesh (USA Standard Test Sieve ASTM E-11 Specification), the ground carbon was pretreated with an acid solution (15%) in a proportion of 60 parts acid to 100 parts ground carbon. The pretreated carbon was loaded with 8% CBT to carbon weight, using dynamic fluidized loading for 2 hrs with 50% bed expansion, and then washed to 5.97% CBT.

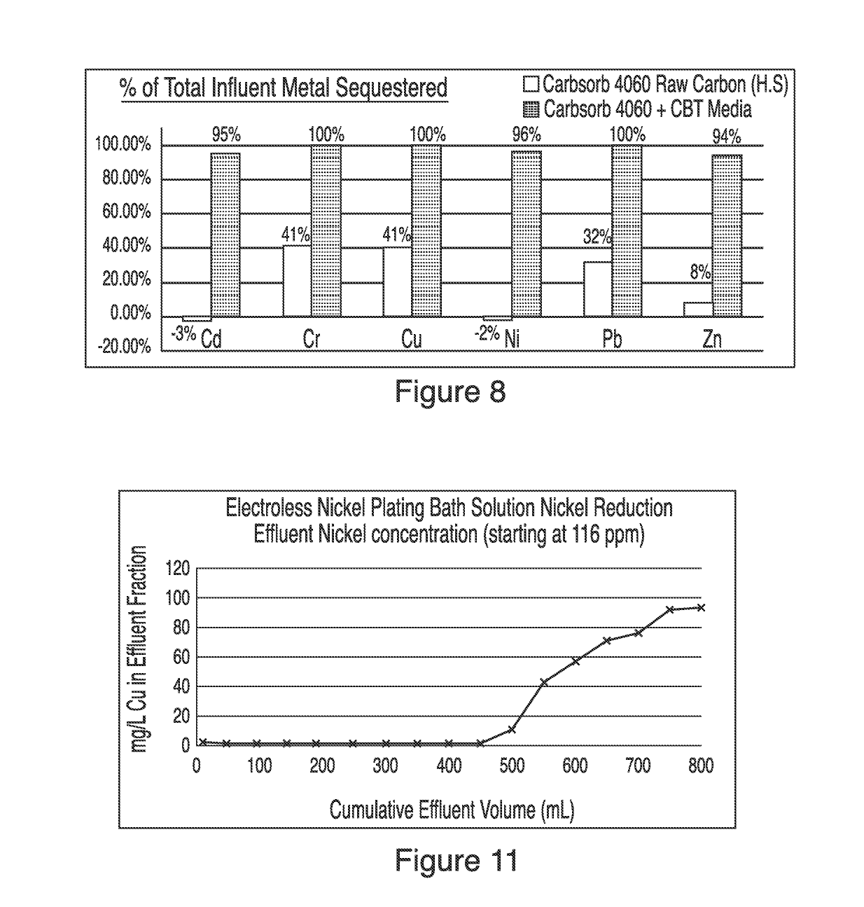

In this experiment a 1 liter solution at pH of 3.5 containing 16 ppm of each of cadmium, chromium, copper, nickel, lead and zinc was pumped through two separate columns each containing 4 grams of plain untreated but sized Calgon Carbsorb GAC and 4 grams of Carbon+CBT prepared as described above. The effluent solutions were tested for the six metals and the metals sequestered by each media graphed in FIG. 8. As can be seen the C+CBT media outperformed the plain carbon with each metal.

### Example 2

Carbon+CBT (C+CBT) Media was prepared as generally described above except that the activated carbon was ground to 40/60 mesh, the ground carbon was pretreated with an acid solution (15%) in a proportion of 60 parts acid to 100 parts ground carbon. The pretreated carbon was loaded with 9.15% CBT to carbon weight, using dynamic fluidized loading for 4 hrs with 33% bed expansion, and then washed to 7.9% CBT.

Arizona lake water containing 500 ppm calcium, 9 ppm potassium, 70 ppm magnesium and 100 ppm sodium was spiked with 10 ppm uranium. This solution was pumped through a 2 gram column of carbon+CBT media prepared as described above at about 2 ml per minute rate. The effluent was tested for the five metals and the results are shown in Table I. Uranium capacity was determined to be 3.5% by weight.

TABLE I
Influent - Lake water spiked with
10 ppm Uranium, original ~90 ppb

| | All in ppm | Ca | K | Mg | Na | U |
|---|---|---|---|---|---|---|
| ph 7.8 | Influent - | 479.8 | 8.25 | 69.4 | 97.95 | 10.45 |
| Effluent | 1600 ml | 511.25 | 9.00 | 70.45 | 99.80 | 0.00 |
| | 5000 ml | 514.00 | 9.05 | 70.10 | 100.23 | 0.00 |
| | 7050 ml | 514.00 | 9.05 | 70.10 | 100.23 | 10.45 |

Media regenerated, 95% uranium recovery in single step process

### Example 3

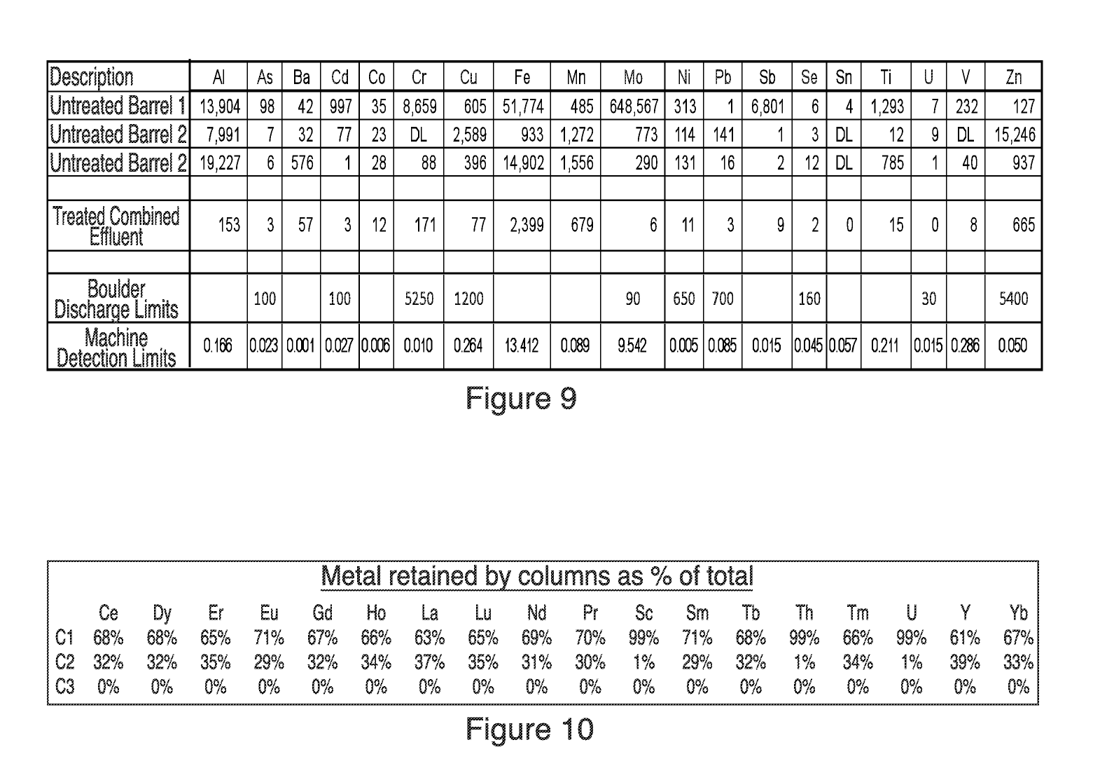

University Laboratory Waste Treatment: Three 55 gallon barrels containing acid/metal waste were sampled for ICP/MS analysis. With starting pH near zero all three were neutralized to pH 3.5 using solid Sodium hydroxide. The solutions were then allowed to precipitate and the supernatant were mixed together and the solution was pumped through four media columns, in series, containing C+CBT media, manufactured as described below at about 50 ml/minute. The comparison of the original metal content in the barrels and the metal content of the combined effluent is shown in FIG. 9. The system reduced all metals to a concentration less than the City of Boulder municipal discharge limits.

Media Used:

Column 1: 800 g Calgon MRX 30/40, 20% acid solution, 60% acid v/carbon g, 12% CBT in Solution, 4 hrs.

Column 2: 900 g Calgon MRX 40/60, 20% acid solution, 60% acid v/carbon g, 12% CBT in solution, 3 hrs; 100 g Calgon MRX 40/60, 22.8% acid solution, 59% acid v/carbon g, 12% CBT in solution, 5 hrs.

Column 3: 670 g, Calgon MRX 40/60, 22.8% acid solution, 59% acid v/carbon g, 12% CBT in solution, 5 hrs; 330 g, Calgon MRX 40/60, 20% acid solution, 60% acid v/carbon g, 12% CBT in solution, 4 hrs.

Column 4: 300 g Lot Calgon MRX-P, Mesh 40/60, 21% acid solution, 98% acid v/carbon g CBT & Co-ligand were loaded.

### Example 4

500 nil solution at pH 3.5 containing Rare Earth Elements (REE) with approximately 5 ppm of each REE metal and slightly smaller amounts of thorium and uranium was pumped through three columns in series holding 2 gm of C+CBT media in each.

The first column, C1 sequestered most of the REE metals and all of Uranium, Thorium and Scandium. Column C2 picked up any metal not sequestered by the first column. No metal reached Column C3. All sequestered metals were recovered and the media regenerated. The results are shown in FIG. 10.

Media Used: Calgon MRX-P, mesh size—30/40, 15% acid solution, 60% acid v/carbon g, 12% CBT in solution, washed to 9.31%.

### Example 5

An industrial waste solution containing chemicals and organics like, sodium hypophosphite, oxycarboxylic acid & organics from solder flux and 3800 ppm nickel was diluted to a level of 116 ppm of nickel. 800 ml of this solution was pumped through 20 gram GAC pretreatment and then through 4 gram C+CBT media leading to a significant nickel reduction. The results of this experiment are shown in FIG. 11. No other system previously tested by the waste producer had succeeded in reducing the nickel to this extent.

Media Used: Calgon MRX 40/60—15% acid solution, 60% acid v/carbon g, 12% CBT in solution loading for 3 hrs, washed down to 9.06% CBT.

What is claimed is:

1. A method of preparing sorptive media, wherein the method comprises: treating a mass of sorptive media with a solution containing a primary metal-binding ligand in a chamber under conditions in which the mass of sorptive media is permitted to move freely as it is treated with the ligand-bearing solution to load the primary metal-binding ligand onto the mass of sorptive media.

2. The method of claim 1, wherein the sorptive media is comprised of granular carbon.

3. The method of claim 1, wherein the primary ligand comprises a benzotriazole or a benzothiazole.

4. The method of claim 1, wherein the primary ligand is carboxybenzotriazole.

5. The method of claim 1, wherein the method further comprises loading a secondary ligand selected from the group comprising dicarboxylic acids, ethylendiaminetetraacetate, and ascorbic acid onto the sorptive media.

6. The method of claim 1, wherein the chamber is less than 100% packed by volume with the activated sorptive media and the primary ligand is loaded onto the sorptive media by a dynamic fluidized loading process.

7. The method of claim 1 wherein the method further comprises pre-treating the mass of sorptive media with an oxidizing agent before it is treated with the primary metal-binding ligand solution.

8. A method of sequestering metals from an aqueous medium comprising: a) loading a primary ligand and optionally, a secondary ligand, onto a sorptive media within a chamber by a process comprising dynamic fluidized loading; and b) passing an aqueous medium containing one or more metals through the chamber containing the sorptive media, the primary ligand, and optionally, a secondary ligand, so that the primary ligand and the secondary ligand bind with one or more metals from the aqueous medium.

9. The method of claim 8, wherein the sorptive media comprises granular carbon.

10. The method of claim 9, wherein the granular carbon has been pre-treated with nitric acid prior to said loading step.

11. The method of claim 8, wherein the primary ligand comprises at least one of a benzotriazole, a benzothiazole, or another metal-binding compound.

12. The method of claim 8, wherein the primary ligand is carboxybenzotriazole.

13. The method of claim 8, wherein the secondary ligand is selected from the group consisting of dicarboxylic acids, ethylendiaminetetraacetate, and ascorbic acid.

14. The method of claim 8, wherein said metal is selected from the group comprising aluminum, arsenic, beryllium, boron, cadmium, chromium, gadolinium, fluorine, mercury, nickel, samarium, selenium, thorium, vanadium, antimony, cobalt, holmium, lithium, molybdenum, scandium, thulium, ytterbium, barium, copper, iron, neodymium, silver, tin, yttrium, cadmium, dysprosium, lanthanum, nickel, strontium, titanium, zinc, cesium, erbium, lead, mercury, palladium, tungsten, thallium, cerium europium, lutetium, pradeodymium, terbium, uranium, manganese, and compounds thereof or mixtures thereof.

15. The method of claim 8, wherein said aqueous medium has a pH of about 1 to 5.

16. The method of claim 8, wherein said aqueous medium has a pH of about 0 to 9.

17. A method of preparing a material for use in treating a fluid containing metals, the method comprising:
a) causing a chamber to be partially filled with a granular activated carbon; and
b) causing a ligand seeding solution to flow through the chamber, wherein pore pressures of the ligand seeding solution within the granular activated carbon are at least high enough to overcome gravitational forces acting on the granular activated carbon within the column, thereby causing movement of at least a portion of the granular activated carbon as the ligand seeding solution is transmitted through the chamber.

18. The method of claim 17, further comprising pre-treating the activated carbon with an oxidizing agent prior to causing the chamber to be partially filled with the activated carbon.

19. The method of claim 18 wherein the oxidizing agent is nitric acid.

20. A system for use in treating a fluid containing metals, comprising: a chamber partially filled with granular activated carbon, wherein the granular activated carbon includes at least one of a primary ligand and a optionally, a secondary ligand, associated with the granular activated carbon by a process of dynamic fluidized loading.

21. The system of claim 20 wherein the chamber is filled with between about 10% to 80% by volume of the granular activated carbon.

22.-26. (canceled)
